(19) United States
(12) Patent Application Publication
(10) Pub. No.: US 2006/0174753 A1
(43) Pub. Date: Aug. 10, 2006

(54) Musical instruments and components manufactured from conductively doped resin-based materials

(76) Inventor: Thomas Aisenbrey, Littleton, CO (US)

Correspondence Address: DOUGLAS R. SCHNABEL, 1531 WEDGEWOOD PLACE, ESSEXVILLE, MI, 48732, US

(21) Appl. No.: 11/378,061

(22) Filed: Mar. 17, 2006

Related U.S. Application Data
(63) Continuation-in-part of application No. 10/877,092, filed on Jun. 25, 2004.
Application No. 10/877,092 is a continuation of application No. 10/309,429, filed on Dec. 4, 2002, now Pat. No. 6,870,516.
Application No. 10/309,429 is a continuation-in-part of application No. 10/075,778, filed on Feb. 14, 2002, now Pat. No. 6,741,221.
(60) Provisional application No. 60/663,290, filed on Mar. 18, 2005.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. G10H 1/00

(52) U.S. Cl. 84/600

(57) ABSTRACT

Musical instruments are formed of a conductively doped resin-based material. The conductively doped resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductively doped resin-based material. The micron conductive powders are metals or conductive non-metals or metal plated non-metals. The micron conductive fibers may be metal fiber or metal plated fiber. Further, the metal plated fiber may be formed by plating metal onto a metal fiber or by plating metal onto a non-metal fiber. Any platable fiber may be used as the core for a non-metal fiber. Superconductor metals may also be used as micron conductive fibers and/or as metal plating onto fibers in the present invention.

### RELATED PATENT APPLICATIONS

This Patent Application claims priority to the U.S. Provisional Patent Application 60/663,290 filed on Mar. 18, 2005, which is herein incorporated by reference in its entirety.

This Patent Application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, now issued as U.S. Pat. No. 6,870,516, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001, all of which are incorporated by reference in their entirety.

### BACKGROUND OF THE INVENTION

(1) Field of the Invention

This invention relates to musical instruments and, more particularly, to musical instruments molded of conductively doped resin-based materials comprising micron conductive powders, micron conductive fibers, or a combination thereof, substantially homogenized within a base resin when molded. This manufacturing process yields a conductive part or material usable within the EMF, thermal, acoustic, or electronic spectrum(s).

(2) Description of the Prior Art

Traditional musical instrument construction uses specific types of wood or other materials in order to achieve particular acoustic responses. In an acoustic guitar, for instance, when a lively warm tone is desired the wood selected is usually mahogany. Mahogany tends to enhance low to mid-range tones and be less responsive to the brighter harsher tones. These resonating properties make mahogany a good choice for the sides and backs of an acoustic guitar. Mahogany is also used for the body and the neck on some electric guitars. When a brighter more metallic sound is desired, then a denser wood such as rosewood is chosen.

In recent years, resin-based materials have been incorporated into instrument designs to reduce cost or to increase durability. Resin-based materials provide advantages of easy mass manufacturing via molding processes of exact replicas of a design pattern. These materials are typically less expensive than wood and provide consistent performance. Unfortunately, it is difficult to make resin-based materials perform, acoustically, like wood. In addition, it is difficult to customize the plastic performance to a particular type of instrument achieving, for example, particular resonance characteristics for each instrument. Providing a resin-based material with excellent acoustic performance is a primary objective of the present invention.

Several prior art inventions relate to musical instruments comprising resin-based materials. U.S. Pat. No. 6,538,183 B2 to Verd teaches a composite stringed musical instrument and a method of manufacture that comprises an exterior shell comprising an epoxy matrix, carbon fiber reinforced composite and an elastomeric sound-damping layer bonded to all or part of the interior surface of the exterior shell. U.S. Pat. No. 4,290,336 to Peavey teaches a molded guitar structure and a method of manufacture that utilizes a guitar body formed of a foamed plastic or similar material that has a clam shell design to allow different areas to be filled with foam to control the resonance properties of the instrument. U.S. Patent Publication US 2003/0140765 A1 to Herman teaches a molded fret board and guitar that utilizes integrally molded frets comprising a mixture of glass beads and resin and where the mixture of glass beads to resin is in the range of about 60:40 to 70:30.

U.S. Patent Publication US 2004/0003700 A1 to Smith et al teaches a guitar neck support rod that utilizes a core of wood that is wrapped with a graphite epoxy material for strengthening the neck of the guitar. U.S. Patent Publication US 2004/0060417 A1 to Janes et al teaches a solid body guitar that is formed with a larger than normal cavity covered with a graphite epoxy composite material in order to increase the volume of the guitar without amplification. U.S. Patent Publication US 2001/0000857 A1 to Hebestreit et al teaches a musical string that is formed with a polymer cover to protect the string from contamination and maintain the liveliness of sound. U.S. Patent Publication US 2003/0053640 A1 to Curtis et al teaches a method of processing out obtrusive periodic noise on a musical instrument by applying the signal to a notch filter having a transfer function that is the inverse of the expected noise signal. U.S. Patent Publication US 2003/0070530 A1 to McAleenan teaches the construction and method of wind musical instruments comprising fiber reinforced composite construction. U.S. Patent Publication US 2003/0106409 A1 to McPherson teaches a neck for a stringed musical instrument that utilizes a carbon fiber insert along the its entire length.

U.S. Patent Publication US 2002/0033088 A1 to Won et al teaches a musical instrument with a body made of polyurethane foam. U.S. Patent Publication US 2004/0074370 A1 to Oskorep teaches a guitar pick that comprises a blend of plastic and a magnetically receptive material. The invention teaches the use of magnetic powders in order to make the plastic pick attracted to a magnetic force. U.S. Patent Publication US 2002/0152880 A1 to Hogue et al teaches a pick-up assembly for a stringed acoustical musical instrument that is designed to eliminate undesirable harmonics. This invention teaches-the use of two identical pick-ups placed back to back with a sound deadening material between.

U.S Patent Publication US 2002/0020281 A1 to Devers teaches an electromagnetic humbucker pick-up for a stringed musical instrument that utilizes two stacked single coil pickups. This invention teaches the alignment of the magnets to be “north to north” in order to approximate the sound characteristic of a single-coil pick-up and the noise canceling characteristic of a humbucker pick-up. U.S. Patent Publication US 2001/0022129 A1 to Damm teaches a single-coil pickup that fits in a humbucking-sized housing for retrofitting and customizing an electric guitar. U.S. Patent Publication US 2003/0196538 A1 to Katchanov et al teaches a musical instrument string that utilizes a polymer core that includes additive particles composed of metal, metal oxides, coloring agents and luminescent agents.

U.S. Patent Publication US 2001/0027716 A1 to Turner teaches a pickup for electric guitars that utilizes a ferromagnetic steel plate between two coils that are wound in opposite directions and six magnetic pole pieces that extend through both coils and the steel plate. U. S. Patent Publication US 2004/0003709 A1 to Kinman teaches a noise sensing bobbin-coil assembly for amplified stringed musical instrument pickups that utilizes a typical single coil pickup construction with an added noise-sensing coil assembly. The noise-sensing coil assembly uses a bobbin that comprises several laminations of a sheet steel material with a dielectric between each lamination.

### SUMMARY OF THE INVENTION

A principal object of the present invention is to provide an effective musical instrument or instrument component.

A further object of the present invention is to provide a method to form a musical instrument or instrument component.

A further object of the present invention is to provide a musical instrument or instrument component molded of conductively doped resin-based materials.

A yet further object of the present invention is to provide a musical instrument or instrument component molded of conductively doped resin-based material where the acoustical, thermal, or electrical characteristics can be altered or the visual characteristics can be altered by forming a metal layer over the conductively doped resin-based material.

A yet further object of the present invention is to improve the acoustical performance of a musical instrument through use of a conductively doped resin-based material.

A yet further object of the present invention is to customize the resonance qualities of a musical instrument through the choice of and the doping percentage of the conductive materials.

In accordance with the objects of this invention, a musical instrument device is achieved. The device comprises a user interface and a vibrating cavity. Inputs from the user interface case air to vibrate in the vibrating cavity. The vibrating cavity comprises conductively doped resin-based material comprising micron conductive materials in a resin-based material.

Also in accordance with the objects of this invention, a musical instrument device is achieved. The device comprises a user interface and a vibrating cavity. Inputs from the user interface case air to vibrate in the vibrating cavity. The vibrating cavity comprises conductively doped resin-based material comprising micron conductive fiber in a resin-based material. The percent by weight of the micron conductive fiber is between about 20% and about 50% of the total weight of the conductively doped resin-based material.

Also in accordance with the objects of this invention, a method to form a musical instrument device is achieved. The method comprises providing a conductively doped, resin-based material comprising micron conductive materials in a resin-based host. A using interface is formed. Conductively doped, resin-based material is molded into a vibrating cavity. Inputs from the user interface case air to vibrate in the vibrating cavity.

### BRIEF DESCRIPTION OF THE DRAWINGS

In the accompanying drawings forming a material part of this description, there is shown:

FIG. 1a illustrates an electric guitar formed of the conductively doped resin-based material according to a first preferred embodiment of the present invention.

FIG. 1b illustrates a drum set formed of the conductively doped resin-based material according to a second preferred embodiment of the present invention.

FIG. 2 illustrates a first preferred embodiment of a conductively doped resin-based material wherein the conductive materials comprise a powder.

FIG. 3 illustrates a second preferred embodiment of a conductively doped resin-based material wherein the conductive materials comprise micron conductive fibers.

FIG. 4 illustrates a third preferred embodiment of a conductively doped resin-based material wherein the conductive materials comprise both conductive powder and micron conductive fibers.

FIGS. 5a and 5b illustrate a fourth preferred embodiment wherein conductive fabric-like materials are formed from the conductively doped resin-based material.

FIGS. 6a and 6b illustrate, in simplified schematic form, an injection molding apparatus and an extrusion molding apparatus that may be used to mold musical instruments of a conductively doped resin-based material.

FIG. 7 illustrates an acoustic guitar formed of the conductively doped resin-based material according to a third preferred embodiment of the present invention.

FIG. 8 illustrates a violin formed of the conductively doped resin-based material according to a fourth preferred embodiment of the present invention.

FIG. 9 illustrates a clarinet formed of the conductively doped resin-based material according to a fifth preferred embodiment of the present invention.

FIG. 10 illustrates a rack mount case formed of the conductively doped resin-based material according to a sixth preferred embodiment of the present invention.

FIG. 11 illustrates an instrument cable formed of the conductively doped resin-based material according to a seventh preferred embodiment of the present invention.

FIG. 12 illustrates a microphone cable formed of the conductively doped resin-based material according to an eighth preferred embodiment of the present invention.

FIG. 13 illustrates a sound snake formed of the conductively doped resin-based material according to a ninth preferred embodiment of the present invention.

FIG. 14 illustrates a wireless guitar system formed of the conductively doped resin-based material according to a tenth preferred embodiment of the present invention.

FIG. 15 illustrates an instrument preamp formed of the conductively doped resin-based material according to an eleventh preferred embodiment of the present invention.

FIG. 16 illustrates an electronic keyboard formed of the conductively doped resin-based material according to a twelfth preferred embodiment of the present invention.

FIG. 17 illustrates an electric guitar pickup formed of the conductively doped resin-based material according to a thirteenth preferred embodiment of the present invention.

FIG. 18 illustrates an acoustic piano formed of the conductively doped resin-based material according to a fourteenth preferred embodiment of the present invention.

### DESCRIPTION OF THE PREFERRED EMBODIMENTS

This invention relates to musical instruments molded of conductively doped resin-based materials comprising micron conductive powders, micron conductive fibers, or a combination thereof, substantially homogenized within a base resin when molded.

The conductively doped resin-based materials of the invention are base resins doped with conductive materials to convert the base resin from an insulator to a conductor. The base resin provides structural integrity to the molded part. The doping material, such as micron conductive fibers, micron conductive powders, or a combination thereof, is substantially homogenized within the resin during the molding process. The resulting conductively doped resin-based material provides electrical, thermal, and acoustical continuity.

The conductively doped resin-based materials can be molded, extruded or the like to provide almost any desired shape or size. The molded conductively doped resin-based materials can also be cut, stamped, or vacuumed formed from an injection molded or extruded sheet or bar stock, over-molded, laminated, milled or the like to provide the desired shape and size. The thermal, electrical, and acoustical continuity and/or conductivity characteristics of articles or parts fabricated using conductively doped resin-based materials depend on the composition of the conductively doped resin-based materials. The type of base resin, the type of doping material, and the relative percentage of doping material incorporated into the base resin can be adjusted to achieve the desired structural, electrical, or other physical characteristics of the molded material. The selected materials used to fabricate the articles or devices are substantially homogenized together using molding techniques and or methods such as injection molding, over-molding, insert molding, compression molding, thermo-set, protrusion, extrusion, calendaring, or the like. Characteristics related to 2D, 3D, 4D, and 5D designs, molding and electrical characteristics, include the physical and electrical advantages that can be achieved during the molding process of the actual parts and the molecular polymer physics associated within the conductive networks within the molded part(s) or formed material(s).

In the conductively doped resin-based material, electrons travel from point to point, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive doping concentration and material makeup, that is, the separation between the conductive doping particles. Increasing conductive loading content reduces interparticle separation distance, and, at a critical distance known as the percolation point, resistance decreases dramatically and electrons move rapidly.

Resistivity is a material property that depends on the atomic bonding and on the microstructure of the material. The atomic microstructure material properties within the conductively doped resin-based material are altered when molded into a structure. A substantially homogenized conductive microstructure of delocalized valance electrons is created within the valance and conduction bands of the molecules. This microstructure provides sufficient charge carriers within the molded matrix structure. As a result, a low density, low resistivity, lightweight, durable, resin based polymer microstructure material is achieved. This material exhibits conductivity comparable to that of highly conductive metals such as silver, copper or aluminum, while maintaining the superior structural characteristics found in many plastics and rubbers or other structural resin based materials.

Conductively doped resin-based materials lower the cost of materials and of the design and manufacturing processes needed for fabrication of molded articles while maintaining close manufacturing tolerances. The molded articles can be manufactured into infinite shapes and sizes using conventional forming methods such as injection molding, over-molding, compression molding, thermoset molding, or extrusion, calendaring, or the like. The conductively doped resin-based materials, when molded, typically but not exclusively produce a desirable usable range of resistivity of less than about 5 to more than about 25 ohms per square, but other resistivities can be achieved by varying the dopant(s), the doping parameters and/or the base resin selection(s).

The conductively doped resin-based materials comprise micron conductive powders, micron conductive fibers, or any combination thereof, which are substantially homogenized together within the base resin, during the molding process, yielding an easy to produce low cost, electrical, thermal, and acoustical performing, close tolerance manufactured part or circuit. The resulting molded article comprises a three dimensional, continuous capillary network of conductive doping particles contained and or bonding within the polymer matrix. Exemplary micron conductive powders include carbons, graphites, amines, eeonomers, or the like, and/or of metal powders such as nickel, copper, silver, aluminum, nichrome, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. Carbon nano-tubes may be added to the conductively doped resin-based material. The addition of conductive powder to the micron conductive fiber doping may improve the electrical continuity on the surface of the molded part to offset any skinning effect that occurs during molding.

The micron conductive fibers may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating materials include, but are not limited to, copper, nickel, cobalt, silver, gold, palladium, platinum, ruthenium, rhodium, and nichrome, and alloys of thereof. Any platable fiber may be used as the core for a non-metal fiber. Exemplary non-metal fibers include, but are not limited to, carbon, graphite, polyester, basalt, melamine, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

Where micron fiber is combined with base resin, the micron fiber may be pretreated to improve performance. According to one embodiment of the present invention, conductive or non-conductive powders are leached into the fibers prior to extrusion. In other embodiments, the fibers are subjected to any or several chemical modifications in order to improve the fibers interfacial properties. Fiber modification processes include, but are not limited to: chemically inert coupling agents; gas plasma treatment; anodizing; mercerization; peroxide treatment; benzoylation; or other chemical or polymer treatments.

Chemically inert coupling agents are materials that are molecularly bonded onto the surface of metal and or other fibers to provide surface coupling, mechanical interlocking, inter-difussion and adsorption and surface reaction for later bonding and wetting within the resin-based material. This chemically inert coupling agent does not react with the resin-based material. An exemplary chemically inert coupling agent is silane. In a silane treatment, silicon-based molecules from the silane bond to the surface of metal fibers to form a silicon layer. The silicon layer bonds well with the subsequently extruded resin-based material yet does not react with the resin-based material. As an additional feature during a silane treatment, oxane bonds with any water molecules on the fiber surface to thereby eliminate water from the fiber strands. Silane, amino, and silane-amino are three exemplary pre-extrusion treatments for forming chemically inert coupling agents on the fiber.

In a gas plasma treatment, the surfaces of the metal fibers are etched at atomic depths to re-engineer the surface. Cold temperature gas plasma sources, such as oxygen and ammonia, are useful for performing a surface etch prior to extrusion. In one embodiment of the present invention, gas plasma treatment is first performed to etch the surfaces of the fiber strands. A silane bath coating is then performed to form a chemically inert silicon-based film onto the fiber strands. In another embodiment, metal fiber is anodized to form a metal oxide over the fiber. The fiber modification processes described herein are useful for improving interfacial adhesion, improving wetting during homogenization, and/or reducing oxide growth (when compared to non-treated fiber). Pretreatment fiber modification also reduces levels of particle dust, fines, and fiber release during subsequent capsule sectioning, cutting or vacuum line feeding.

The resin-based structural material may be any polymer resin or combination of compatible polymer resins. Non-conductive resins or inherently conductive resins may be used as the structural material. Conjugated polymer resins, one example being polythiophene, may be used as the structural material. Complex polymer resins, examples being polyimide and polyamide, may be used as the structural material. Inherently conductive resins may be used as the structural material. The dielectric properties of the resin-based material will have a direct effect upon the final electrical performance of the conductively doped resin-based material. Many different dielectric properties are possible depending on the chemical makeup and/or arrangement, such as linking, cross-linking or the like, of the polymer, co-polymer, monomer, ter-polymer, or homo-polymer material. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material doped with micron conductive powders, micron conductive fibers, or in combination thereof can be molded, using conventional molding methods such as injection molding or over-molding, or extrusion to create desired shapes and sizes. The molded conductively doped resin-based materials can also be stamped, cut or milled as desired to form create the desired shapes and form factor(s). The doping composition and directionality associated with the micron conductors within the doped base resins can affect the electrical and structural characteristics of the articles and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming articles that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductively doped resin-based material may also be formed into a prepreg laminate, cloth, or webbing. A laminate, cloth, or webbing of the conductively doped resin-based material is first homogenized with a resin-based material. In various embodiments, the conductively doped resin-based material is dipped, coated, sprayed, and/or extruded with resin-based material to cause the laminate, cloth, or webbing to adhere together in a prepreg grouping that is easy to handle. This prepreg is placed, or laid up, onto a form and is then heated to form a permanent bond. In another embodiment, the prepreg is laid up onto the impregnating resin while the resin is still wet and is then cured by heating or other means. In another embodiment, the wet lay-up is performed by laminating the conductively doped resin-based prepreg over a honeycomb structure. In another embodiment, the honeycomb structure is made from conductively doped, resin-based material. In yet another embodiment, a wet prepreg is formed by spraying, dipping, or coating the conductively doped resin-based material laminate, cloth, or webbing in high temperature capable paint.

Prior art carbon fiber and resin-based composites are found to display unpredictable points of failure. In carbon fiber systems there is little if any elongation of the structure. By comparison, in the present invention, the conductively doped resin-based material, even if formed with carbon fiber or metal plated carbon fiber, displays greater strength of the mechanical structure due to the substantial homogenization of the fiber created by the moldable capsules. As a result a structure formed of the conductively doped resin-based material of the present invention will maintain structurally even if crushed while a comparable carbon fiber composite will break into pieces.

The conductively doped resin-based material of the present invention can be made resistant to corrosion and/or metal electrolysis by selecting micron conductive fiber and/or micron conductive powder dopants and base resins that are resistant to corrosion and/or metal electrolysis. For example, if a corrosion/electrolysis resistant base resin is combined with fibers/powders or in combination of such as stainless steel fiber, inert chemical treated coupling agent warding against corrosive fibers such as copper, silver and gold and or carbon fibers/powders, then corrosion and/or metal electrolysis resistant conductively doped resin-based material is achieved. Another additional and important feature of the present invention is that the conductively doped resin-based material of the present invention may be made flame retardant. Selection of a flame-retardant (FR) base resin material allows the resulting product to exhibit flame retardant capability. This is especially important in applications as described herein.

The substantially homogeneous mixing of micron conductive fiber and/or micron conductive powder and base resin described in the present invention may also be described as doping. That is, the substantially homogeneous mixing transforms a typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder within a base resin.

As an additional and important feature of the present invention, the molded conductor doped resin-based material exhibits excellent thermal dissipation characteristics. Therefore, articles manufactured from the molded conductor doped resin-based material can provide added thermal dissipation capabilities to the application. For example, heat can be dissipated from electrical devices physically and/or electrically connected to an article of the present invention.

As a significant advantage of the present invention, articles constructed of the conductively doped resin-based material can be easily interfaced to an electrical circuit or grounded. In one embodiment, a wire can be attached to conductively doped resin-based articles via a screw that is fastened to the article. For example, a simple sheet-metal type, self tapping screw can, when fastened to the material, can achieve excellent electrical connectivity via the conductive matrix of the conductively doped resin-based material. To facilitate this approach a boss may be molded as part of the conductively doped resin-based material to accommodate such a screw. Alternatively, if a solderable screw material, such as copper, is used, then a wire can be soldered to the screw is embedded into the conductively doped resin-based material. In another embodiment, the conductively doped resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the article and a grounding wire.

Where a metal layer is formed over the surface of the conductively doped resin-based material, any of several techniques may be used to form this metal layer. This metal layer may be used for visual enhancement of the molded conductively doped resin-based material article or to otherwise alter performance properties. Well-known techniques, such as electroless metal plating, electro plating, electrolytic metal plating, sputtering, metal vapor deposition, metallic painting, or the like, may be applied to the formation of this metal layer. If metal plating is used, then the resin-based structural material of the conductively doped, resin-based material is one that can be metal plated. There are many of the polymer resins that can be plated with metal layers. For example, GE Plastics, SUPEC, VALOX, ULTEM, CYCOLAC, UGIKRAL, STYRON, CYCOLOY are a few resin-based materials that can be metal plated. Electroless plating is typically a multiple-stage chemical process where, for example, a thin copper layer is first deposited to form a conductive layer. This conductive layer is then used as an electrode for the subsequent plating of a thicker metal layer.

A typical metal deposition process for forming a metal layer onto the conductively doped resin-based material is vacuum metallization. Vacuum metallization is the process where a metal layer, such as aluminum, is deposited on the conductively doped resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductively doped resin-based material of the present invention facilitates the use of extremely efficient, electrostatic painting techniques.

The conductively doped resin-based materials can be contacted in any of several ways. In one embodiment, a pin is embedded into the conductively doped resin-based material by insert molding, ultrasonic welding, pressing, or other means. A connection with a metal wire can easily be made to this pin and results in excellent contact to the conductively doped resin-based material conductive matrix. In another embodiment, a hole is formed in to the conductively doped resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductively doped resin-based material. In this case, a hole is formed in the conductively doped resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldered.

Another method to provide connectivity to the conductively doped resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductively doped resin-based material at the location of the applied solderable ink. Many other types of solderable inks can be used to provide this solderable surface onto the conductively doped resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductively doped resin-based material may be formed of the present invention to create a magnetic or magnetizable form of the material. Ferromagnetic micron conductive fibers and/or ferromagnetic conductive powders are substantially homogenized with the base resin. Ferrite materials and/or rare earth magnetic materials are added as a conductive doping to the base resin. With the substantially homogeneous mixing of the ferromagnetic micron conductive fibers and/or micron conductive powders, the ferromagnetic conductively doped resin-based material is able to produce an excellent low cost, low weight, high aspect ratio magnetize-able item. The magnets and magnetic devices of the present invention can be magnetized during or after the molding process. Adjusting the doping levels and or dopants of ferromagnetic micron conductive fibers and/or ferromagnetic micron conductive powders that are homogenized within the base resin can control the magnetic strength of the magnets and magnetic devices. By increasing the aspect ratio of the ferromagnetic doping, the strength of the magnet or magnetic devices can be substantially increased. The substantially homogenous mixing of the conductive fibers/powders or in combinations there of allows for a substantial amount of dopants to be added to the base resin without causing the structural integrity of the item to decline mechanically. The ferromagnetic conductively doped resin-based magnets display outstanding physical properties of the base resin, including flexibility, moldability, strength, and resistance to environmental corrosion, along with superior magnetic ability. In addition, the unique ferromagnetic conductively doped resin-based material facilitates formation of items that exhibit superior thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fibers/powders or combinations there of in a cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductively doped resin-based material may be magnetized, after molding, by exposing the molded article to a strong magnetic field. Alternatively, a strong magnetic field may be used to magnetize the ferromagnetic conductively doped resin-based material during the molding process.

The ferromagnetic conductively doped is in the form of fiber, powder, or a combination of fiber and powder. The micron conductive powder may be metal fiber or metal plated fiber or powders. If metal plated fiber is used, then the core fiber is a platable material and may be metal or non-metal. Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials. A ferromagnetic conductive doping may be combined with a non-ferromagnetic conductive doping to form a conductively doped resin-based material that combines excellent conductive qualities with magnetic capabilities.

The sound resonating properties of the conductively doped resin-based material can be adjusted by varying the base resin, the conductive fibers, and/or the conductive powder selection. The ratio of fiber to base resin and the overall geometrical design also help to determine the sound resonating properties of the material. A heavier loading of fibers will create a heavier denser item that will impart a very bright tone due to its dense nature. It is also possible to use a base resin of higher density and a lower fiber loading and get similar results.

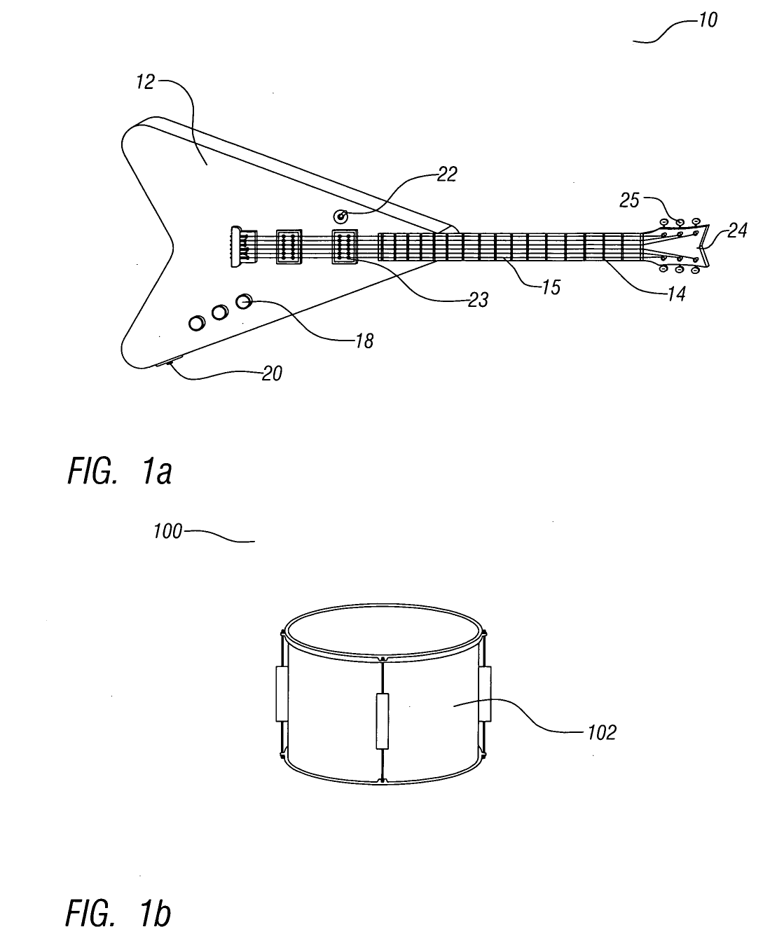

Referring now to FIG. 1a, a first preferred embodiment of the present invention is illustrated. An electric guitar 10 is shown. In the embodiment, any component, or several components, of the electric guitar 10 comprises the conductively doped resin-based material. In various embodiments, the body 12, neck 24, fingerboard 15, frets 14, strings 16, potentiometers 18, output jack 20, and/or the toggle switch 22 comprise the conductively doped resin-based material. In this preferred embodiment, the body 12 of the electric guitar 10 is molded of the conductively doped resin-based material of the present invention. Typically, an electric guitar 10 is designed to minimize the vibration of the body 12 to allow the pickups 23 to detect the vibration of the strings 16. The conductively doped resin-based guitar body 12 is preferably formed with a percent conductive loading, by weight, such that the sound vibration of the body 12 is minimal. The electric guitar body 12 is molded with the cavities in place to allow for placement of the neck 24, pickups 23, potentiometers 18, toggle switch 22, and the output jack 20.

Traditional electric guitar building techniques require the builder to cut the wooden body into the desired shape and to router the cavities for the neck and the electronics. The cavities that hold the electronic components are also often painted with conductive paint, or sealed with metallic tape, and then grounded to the bridge in order to shield the electronics from electromagnetic interference and to protect the user from a possible shock hazard.

In the present invention, these cavities are molded into the conductively doped resin-based electric guitar body 12. As a result, manufacturing steps are eliminated and the inherent conductive properties of the conductively doped resin-based material provide excellent shielding. The body 12 for the electric guitar 10 of this embodiment can also be painted by electrostatic means or metal plated and/or metal coated.

In another preferred embodiment, the frets 14 and the fingerboard 15 are molded of the conductively doped resin-based material of the present invention. Typical guitar construction utilizes frets 14 manufactured from a combination of nickel and silver or stainless steel. The frets 14 are then cut to length and pressed into slots that have been cut in the fingerboard 15. In one embodiment of the present invention, the frets 14 and fingerboard 15 are bolded together in the guitar 12. In another preferred embodiment the frets 14 are extruded from the conductively doped resin-based material and cut to the desired size. The frets 14 are then metal plated and/or metal coated before they are pressed into the slots that are molded, milled or otherwise formed into the fingerboard 15. In another embodiment the frets 14 are not plated with metal. The base resin selected for forming the frets 14 and the fingerboard 15 can be from any number of resins that will produce an extremely hard smooth surface and remain resistant to dirt and other corrosives from the musician's hand.

Typical guitar construction utilizes a neck that is either bolted or glued to the body. The neck also typically has a threaded rod, called a truss rod, which is embedded into a channel in the center of the neck just below the fingerboard. The truss rod is used to adjust the curvature of the neck in order to allow for a slight concave bow. Too much bow in the neck requires a greater amount of downward pressure on the strings to make contact with the frets and makes the instrument difficult to play. Conversely, if there is not enough bow in the neck, the strings will buzz or rattle against the frets and will cause the notes to be indistinguishable. The truss rod allows the guitar player to set the amount of bow in the neck to his desired preference. Seasonal humidity changes also affect the guitar neck settings and often force a re-adjustment.

In another preferred embodiment the neck 24 for the electric guitar 10 is molded of the conductively doped resin-based material of the present invention and then joined to the neck pocket on the body 12. In another embodiment the neck 24 is first formed of the conductively doped resin-based material and then bolted into the neck pocket on the body 12 by gluing, ultrasonic welding, chemical solvent, or the like. In yet another embodiment, the neck and the body are formed as one piece in the molding process. The neck 24 is preferably molded with an integrated slot for the truss rod and holes for the tuning pegs 25. A great deal of time and labor is thereby eliminated as compared to traditional guitar manufacturing methods.

In another preferred embodiment, the toggle switch 22, the output jack 20, and the potentiometers 18 or (pots) are formed of the conductively doped resin-based material of the present invention. The toggle switch 22 is used to select the desired pickup that is allowed to feed the output jack 20 into an amplifier. Typical toggle switch construction utilizes metal contact points and metal connectors. The toggle switch 22 in this preferred embodiment uses the conductively doped resin-based material for the electrical contact points as well as the connectors for the wiring.

Typical guitar construction utilizes volume and tone pots 18 to allow the musician to “color” the sound that is amplified. These pots 18 utilize contact points and connectors formed of metal. In another preferred embodiment of the present invention, the volume and tone pots 18 have contact points and electrical connectors that are formed of the conductively doped resin-based material of the present invention.

Typical guitar construction utilizes an output jack 20 to allow a conductor with a ¼ inch phone jack on the end to plug into it. These output jacks 20 utilize contact points and electrical connectors formed of metal. In another preferred embodiment of the present invention, the output jack 20 is formed with contact points and electrical connectors formed of the conductively doped resin-based material of the present invention.

Referring now to FIG. 1b, a second preferred embodiment of the present invention is illustrated. A drum set 100 is shown. The drum set 100 comprises the conductively doped resin-based material of the present invention. In the embodiment the drum shells 102 are formed of the conductively doped resin-based material.

Typical drum construction utilizes several alternating plies of wood glued together to form the drum shell. The wood selected is typically birch, beech, mahogany, or maple. The wood selection is typically based on the desired tonal quality and properties of the drum set. The wooden plies that form the drum shell are then stained, lacquered, or covered with a resin cover to protect it from moisture or other wood damaging elements.

In this embodiment the drum shells 102 are extruded to form the desired shape. The desired sound resonating properties are achieved by varying the base resin, the conductive fibers, and/or the conductive powder selection in the material. By selecting a higher density base resin or a heaver fiber loading content, the conductively doped resin-based material, when formed, will simulate a more dense wood such as maple. In one embodiment the drum shells 102 are painted with a conductive paint. In another embodiment the drum shells 102 are metal coated and/or metal plated. In yet another embodiment the drum shells 102 are formed of the conductively doped resin-based material with an additive or dye in the base resin used to color the drum shells 102 to the desired color.

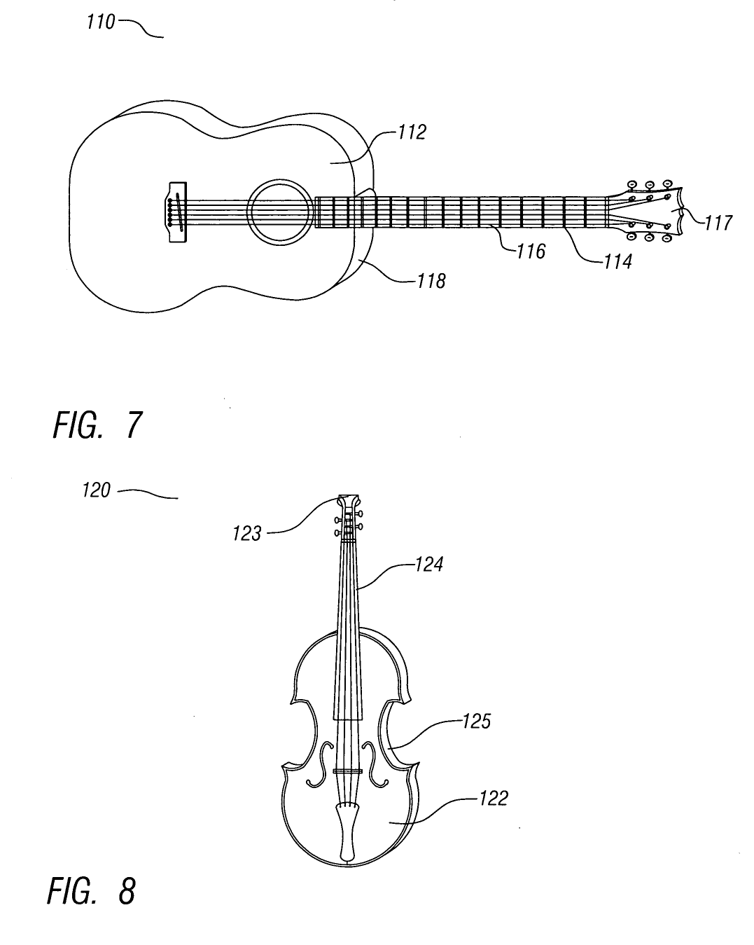

Referring now to FIG. 7, a third preferred embodiment of the present invention is illustrated. An acoustic guitar 110 is shown. The acoustic guitar 110 comprises the conductively doped resin-based material of the present invention. In the embodiment, any component, or several components, of the acoustic guitar 110 comprises the conductively doped resin-based material. In various embodiments, the top 112, neck 117, fingerboard 116, frets 114, sides 118, and/or the back comprise the conductively doped resin-based material.

Typical acoustic guitar construction utilizes a back and sides formed of mahogany or rosewood with a spruce or pine top. The back and sides help to reflect the sound of the strings to the top of the body. The top is typically much thinner than the back and sides allowing it to resonate more freely at the frequency of the strings and to project the sound. The neck is typically made of mahogany with a rosewood or ebony fingerboard. The neck is usually glued to the body at the twelfth or fourteenth fret.

In one preferred embodiment the back and the sides 118 are molded of the conductively doped resin-based material as one integrated section of the acoustic guitar 110. The conductive loading percentage, by weight, and the base resin are selected to allow greater reflection and less absorption of the sound waves. This selection allows the acoustic guitar back and sides 118 to mimic the acoustical properties and the tonal response of the natural wood. In another embodiment the back is formed of the conductively doped resin-based material and the sides are formed of wood. In yet another embodiment the back and sides are each formed of the conductively doped resin-based material separately. The back and sides 118 are then joined together by gluing, ultrasonic welding, chemical solvent, or the like.

In another preferred embodiment, the top 112 of the acoustic guitar 110 is molded of the conductively doped resin-based material of the present invention. The conductive loading percentage, by weight, and the base resin are chosen to allow greater absorption and less reflection of sound waves. This selection allows the acoustic guitar top 112 to mimic the acoustical properties and the tonal response of the natural wood.

Typical guitar construction utilizes a neck that is either bolted or glued to the body. The neck also typically has a threaded rod, called a truss rod, that is embedded into a channel in the center of the neck just below the fingerboard. The truss rod is used to adjust the curvature of the neck in order to allow for a slight concave bow. Too much bow in the neck requires a greater amount of downward pressure on the strings to make contact with the frets and makes the instrument difficult to play. Conversely, if there is not enough bow in the neck the strings will buzz or rattle against the frets and will cause the notes to be indistinguishable. The truss rod allows the guitar player to set the amount of bow in the neck to his desired preference. Seasonal humidity changes also affect the guitar neck settings and often force a re-adjustment.

In one preferred embodiment the neck 117 for the acoustic guitar 110 is molded of the conductively doped resin-based material of the present invention and then joined into the neck pocket on the body by gluing, ultrasonic welding, chemical solvent or the like. In another embodiment the neck 117 is formed and then bolted into the neck pocket on the body. In yet another embodiment, the neck 117, the sides, and the back are formed as one piece in the molding process. The neck 117 is molded with an integrated slot for the truss rod and holes for the tuning pegs thereby eliminating a great deal of time and labor as compared to traditional guitar manufacturing methods.

In another preferred embodiment, the frets 114 and the fingerboard 116 are molded of the conductively doped resin-based material of the present invention. Typical guitar construction utilizes frets 114 manufactured from a combination of nickel and silver or stainless steel. The frets 114 are then cut to length and pressed into slots that have been cut in the fingerboard 116. In one preferred embodiment, the frets 114 and fingerboard 116 are molded together of the conductively doped resin-based material. In another preferred embodiment the frets 114 are extruded from the conductively doped resin-based material and cut to the desired size. The frets 114 are then metal plated and/or metal coated before they are pressed into the slots that are molded, milled or otherwise formed into the fingerboard 116. In another embodiment the frets 114 are not plated with metal. The base resin selected for forming the frets 114 and the fingerboard 116 can be from any number of resins that will produce an extremely hard smooth surface and remain resistant to dirt and other corrosives from the musician's hand.

Referring now to FIG. 8, a fourth preferred embodiment of the present invention is illustrated. A violin 120 is shown. The violin 120 comprises the conductively doped resin-based material of the present invention. In the embodiment, any component, or several components, of the violin 120 comprises the conductively doped resin-based material of the present invention. In various embodiments, the top 122, neck 123, back and sides 125, fingerboard 124 and/or the strings comprise the conductively doped resin-based material.

Traditional violin construction uses specific types of wood in order to achieve particular acoustic responses. For instance, maple or sycamore is used almost exclusively for the back and sides and pine or spruce is used for the tops. The fingerboard is typically ebony or rosewood.

In one preferred embodiment, the top 122 for the violin 120 is molded from the conductively doped resin-based material of the present invention. The conductive loading percentage, by weight, and the base resin are chosen to allow greater absorption and less reflection of the sound waves. This selection allows the violin top 122 to mimic the acoustical properties and the tonal response of the natural wood. In this embodiment the top 122 is molded to shape and joined to the sides by gluing, ultrasonic welding, chemical solvent, or the like. Specific design thickness and tolerances are incorporated into the molding process and thereby eliminate a great deal of labor and machining processes over traditional methods.

In another preferred embodiment, the sides 125 and back for the violin 120 are molded from the conductively doped resin-based material of the present invention. The conductive loading percentage, by weight, and the base resin are chosen to allow less absorption and greater reflection of the sound waves. This selection allows the violin sides 125 and back to mimic the acoustical properties and the tonal response of the natural wood.

In one embodiment the sides 125 and the back are molded together and joined to the top 122 by gluing, ultrasonic welding, chemical solvent, or the like. In another embodiment, the sides 125 and the back are formed individually and joined by gluing, ultrasonic welding, chemical solvent, or the like. Specific design thickness and tolerances are incorporated into the molding process and thereby eliminate a great deal of labor and machining processes over traditional methods.

In another preferred embodiment, the neck 123 and the fingerboard 124 are molded from the conductively doped resin-based material of the present invention. The conductive loading percentage, by weight, and the base resin are chosen to allow less absorption and greater reflection of the sound waves. This selection allows the violin neck 123 and fingerboard 124 to mimic the acoustical properties and the tonal response of the natural wood. In one embodiment, the neck 123 and the fingerboard 124 are molded together and joined to the top 122 and sides 125 by gluing, ultrasonic welding, chemical solvent, or the like. In another embodiment, the neck 123 and the fingerboard 124 are formed individually and joined by gluing, ultrasonic welding, chemical solvent, or the like. Then the neck 123 and fingerboard 124 assemblies are joined to the sides 125 and top 122 by gluing, ultrasonic welding, chemical solvent, or the like. Specific design thickness and tolerances are incorporated into the molding process and thereby eliminate a great deal of labor and machining processes over traditional methods.

Traditional violin construction utilizes a “sound post” that is positioned between the top and back of the instrument. The placement and length of the sound post helps to determine the frequency response and tonal quality of the violin. A spruce rod is typically used as the sound post. The position for the sound post is usually just ahead of the bridge towards the smaller strings slightly below center. The sound post is adjusted to the best position for tonal response by the builder after the final assembly. Since the violin is made of wood and a great deal of acoustical variances can occur, the exact location for each violin is different. The violin 120 formed of the conductively doped resin-based material of the present invention eliminates most of the variables that are present with typical wooden construction. The design consistency allows the sound post to be formed, in place, integrally with either the back or the top 122.

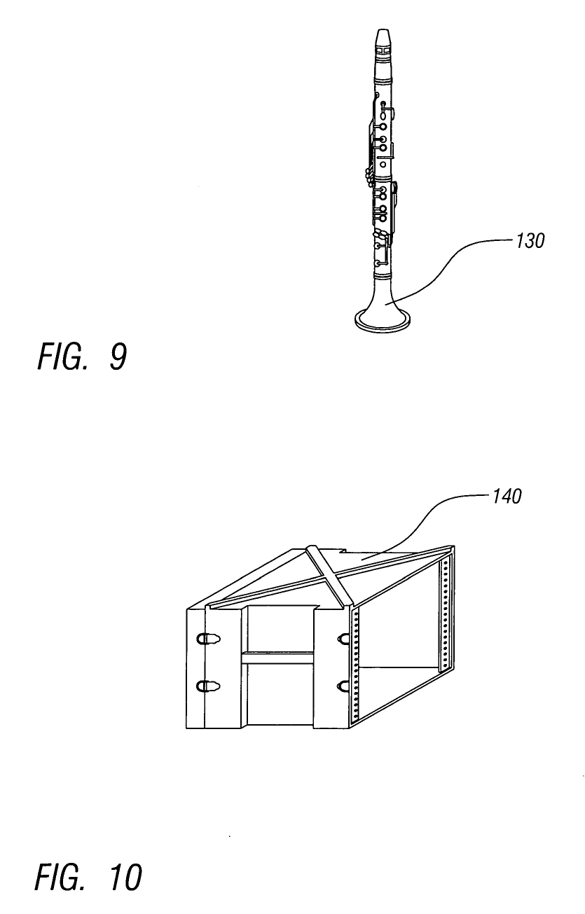

Referring now to FIG. 9, a fifth preferred embodiment of the present invention is illustrated. A clarinet 130 is shown. The clarinet 130 comprises the conductively doped resin-based material of the present invention. In the embodiment, any component or several components comprise the conductively doped resin-based material.

Traditional clarinet construction uses either granadilla wood or rosewood for the body construction. The wooden clarinet bodies will degrade over time due to saliva, finger oils, and corrosives. When the wooden clarinet body ages it tends to deform at different degrees in different specific areas or sections causing it to be out of tune and unplayable.

In one preferred embodiment, the clarinet body 130 is molded from the conductively doped resin-based material of the present invention. The conductive loading percentage, by weight, and the base resin are chosen to allow greater reflection and less absorption of the sound waves. This selection allows the clarinet body 130 to mimic the acoustical properties and the tonal response of the natural wood. In the embodiment, the body 130 is formed by extrusion and the holes are drilled for the finger holes and hardware. In another embodiment the hardware and finger holes are integrated into the mold design.

The clarinet formed from the conductively doped resin-based material exhibits better long term stability and sound integrity than a wooden instrument. This is due to the resin-based material properties that keep the instrument non-reactive, or much less reactive, to environmental humidity and moisture changes. The base resin utilized in forming the clarinet 130 is chosen from a list of possible resins that possess the characteristics of being non-reactive to acids and oils that are found in the skin and saliva.

Referring now to FIG. 9, a sixth preferred embodiment of the present invention is illustrated. A set of rack mount cases 140 is shown. Each rack mount case 140 comprises the conductively doped resin-based material of the present invention. In the embodiment the rack mount case 140 is molded of the conductively doped resin-based material.

The rack mount case 140 is used to transport and protect various musical electronic components such as a sound mixer, a power amplifier, an effects processor, and the like. The rack mount case 140 formed of the conductively doped resin-based material is designed to protect the components during transport. The rack mount case also provides an excellent electromagnetic shield while the electrical components are in operation to filter out unwanted electromagnetic interference. Another advantage of forming the case 140 of the conductively doped resin-based material is its ability to dissipate heat and static electrical charges.

Referring now to FIG. 11, a seventh preferred embodiment of the present invention is illustrated. A musical instrument cable 150 is shown. The musical instrument cable 150 comprises the conductively doped resin-based material of the present invention. In the embodiment, any component or several components of the musical instrument cable 150 comprises the conductively doped resin-based material. In various embodiments, the ¼ inch phone jack connectors 152, and the conductors 154 are formed of the conductively doped resin-based material.

In one preferred embodiment, the ¼ inch phone jack connectors 152, for the musical instrument cable 150, are molded from the conductively doped resin-based material of the present invention. After the molding process the 14 inch jacks 152 are metal plated and/or metal coated. Typical musical instrument cable construction utilizes metal ¼ phone jack connectors 152 at each end. The ¼ inch phone jack connectors 152 allow for a shielded one-conductor cable to interface between the instrument and the amplifier. In one embodiment, the ¼ inch phone jacks 152 are soldered or otherwise electrically connected to the ends of the conductors 154 in the cable 150. In another embodiment the ¼ inch phone jack connectors 152 are formed of the conductively doped resin-based material and then soldered or otherwise electrically connected to the ends of the conductor 154 without being metal plated and/or metal coated.

In another preferred embodiment, the conductor 154 is formed of the conductively doped resin-based material of the present invention. The conductor 154 is formed by co-extruding the center conductive core of the conductively doped resin-based material with a first layer of a non conductive resin-based material, a second layer of shielding formed of the conductively doped resin-based material and an outer insulating layer of non conductive resin-based material. In another embodiment the center conductive core is formed of metal and the shielding is formed of the conductively doped resin-based material. In yet another embodiment, the center conductive core is formed of the conductively doped resin-based material and a braided shielding is formed of metal.

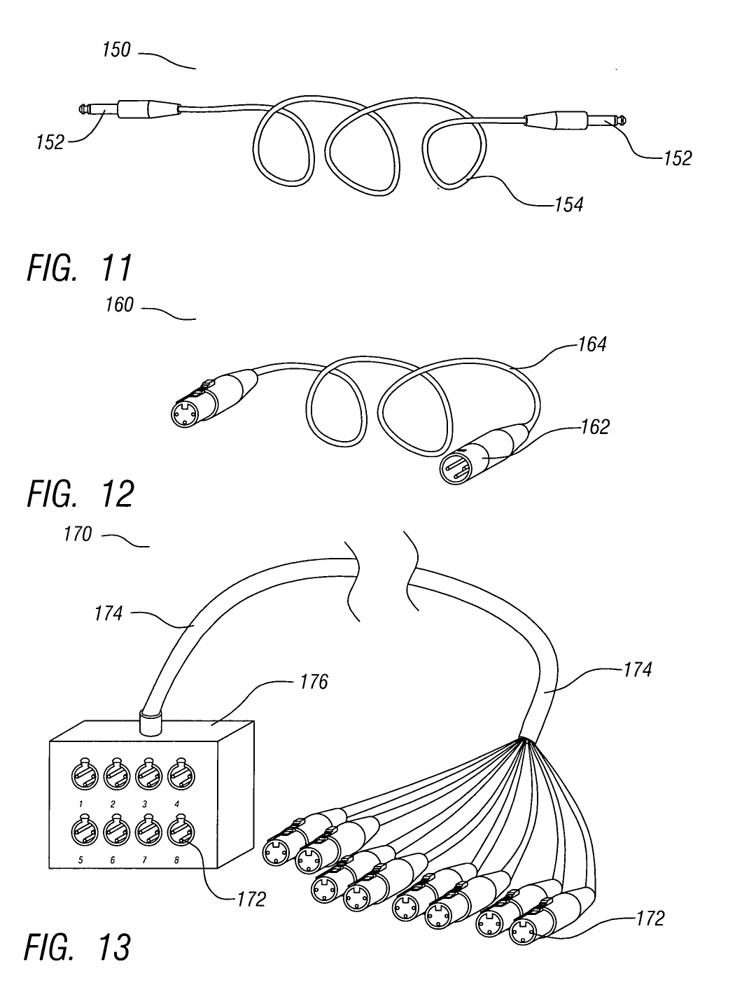

Referring now to FIG. 12, an eighth preferred embodiment of the present invention is illustrated. A microphone cable 160 is shown. The microphone cable 160 comprises the conductively doped resin-based material of the present invention. In the embodiment, any component or several components of the microphone cable 160 comprises the conductively doped resin-based material. In various embodiments, the XLR connectors 162, and the conductor 164 is formed of the conductively doped resin-based material.

In one preferred embodiment, the XLR connectors 162 for the microphone cable 160 are molded from the conductively doped resin-based material of the present invention. After the molding process the XLR connectors 160 are metal plated and/or metal coated. Typical microphone cable construction utilizes metal XLR connectors 162 at each end. The XLR connectors 162 allow for a shielded three-conductor cable to interface between the microphone and the sound mixer. In one embodiment, the XLR connectors 162 are soldered or otherwise electrically connected to the ends of the conductors 164 in the cable 160. In another embodiment the XLR connectors 162 are formed of the conductively doped resin-based material and then soldered or otherwise electrically connected to the ends of the conductor 164 without being metal plated and/or metal coated.

In another preferred embodiment, the conductor 164 is formed of the conductively doped resin-based material of the present invention. The conductor 164 is formed by co-extruding three conductive cores of the conductively doped resin-based material each having an outer insulating layer of a non conductive resin-based material. The three conductive cores are covered together with a second outer layer of non conductive resin-based material. After the second outer layer is formed, a layer of shielding comprising the conductively doped resin-based material is formed with an outer insulating layer of non conductive resin-based material. In another embodiment the center conductive cores are formed of metal and the shielding is formed of the conductively doped resin-based material. In yet another embodiment, the center conductive cores are formed of the conductively doped resin-based material and a braided shielding is formed of metal.

Referring now to FIG. 13, a ninth preferred embodiment of the present invention is illustrated. A sound snake 170 is shown. The sound snake 170 comprises the conductively doped resin-based material of the present invention. In one embodiment, any component or several components of the sound snake 170 comprise the conductively doped resin-based material. In various embodiments, the connectors, conductors 174, and the chassis box 176, are formed of the conductively doped resin-based material of the present invention.

Typical sound snake construction utilizes a plurality of three-conductor wires with male XLR connectors at one end. The other end of the sound snake has a chassis box with a plurality of corresponding female XLR connectors. The entire sound snake is covered by a braided metal shielding that connects to the chassis box and each individual male and female XLR connector.

In this preferred embodiment, the XLR connectors 172 for the sound snake 170 are molded from the conductively doped resin-based material of the present invention. After the molding process the XLR connectors 172 are metal plated and/or metal coated. The XLR connectors 172 allow for a shielded three-conductor cable to interface between the microphone and the sound mixer. In one embodiment, the XLR connectors 172 are soldered or otherwise electrically connected to the ends of the conductors 174 in the sound snake 170. In another embodiment, the XLR connectors 172 are formed of the conductively doped resin-based material and then soldered or otherwise electrically connected to the ends of the conductor 174 without being metal plated and/or metal coated.

In another preferred embodiment, the conductors 174 are formed of the conductively doped resin-based material of the present invention. The conductors are formed much like the microphone cable 160 in the previous embodiment of the present invention. In one embodiment, conductor cores and shielding are formed of the conductively doped resin-based material. In another embodiment, the conductor cores are formed of the conductively doped resin-based material and a braided shielding is formed of metal. In yet another embodiment, the conductor cores are formed of metal and the shielding is formed of the conductively doped resin-based material.

In another preferred embodiment, the chassis box 176 is molded from the conductively doped resin-based material of the present invention. Typical sound snake construction utilizes a chassis box 176 formed from aluminum. The chassis box in this preferred embodiment is molded with allowances in the design for the female XLR connectors 172 and the conductor attachments. The conductively doped resin-based material provides excellent electromagnetic shielding, grounding, and structural stability for the chassis box 176.

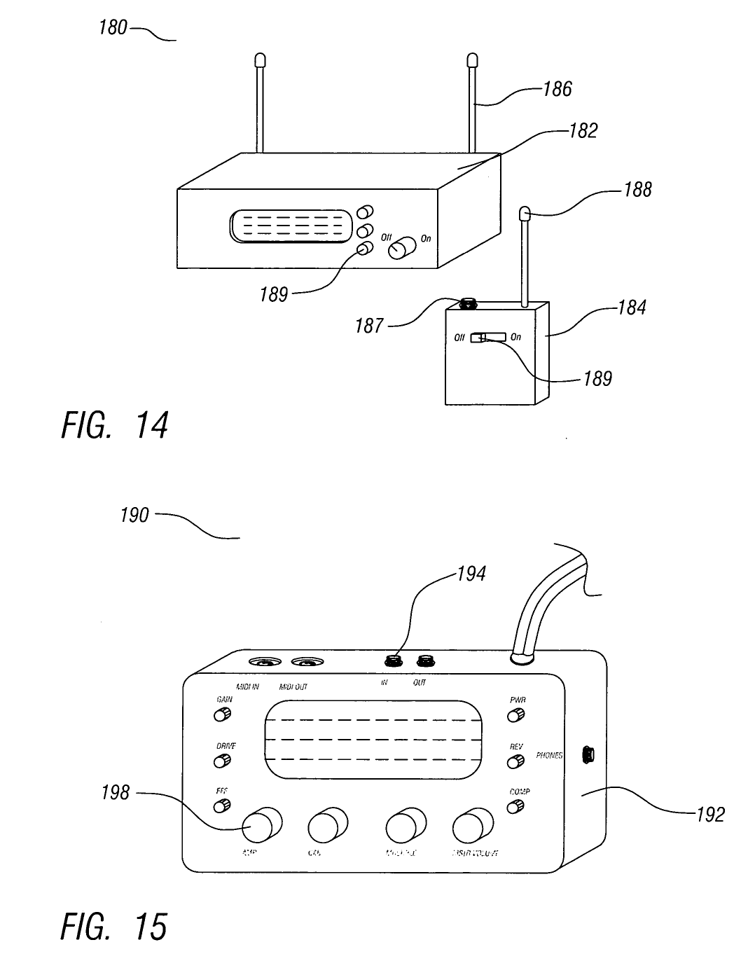

Referring now to FIG. 14, a tenth preferred embodiment of the present invention is illustrated. A wireless transmitter/receiver system 180 is shown. The wireless system 180 comprises the conductively doped resin-based material of the present invention. In various embodiments, the antennas 186 and 188, transmitter case 184, receiver case 182, key pads 189, and/or the connectors 187, are formed of the conductively doped resin-based material of the present invention.

In one preferred embodiment, the transmitter antenna 188 and the receiver antenna 186 comprises the conductively doped resin-based material. A wide variety of antenna structures are easily formed of the conductively doped resin-based material of the present invention. Monopole, dipole, geometric shapes, 2D, 3D, 4D, 5D, isotropic structures, planar, inverted F, PIFA, and the like, are all within the scope of the present invention. The antenna design can be molded by, for example, injection molding. The molded antenna shape determines the resonant frequency response of the antenna.

In another embodiment the outside case for the transmitter 184 and the receiver 182 comprises the conductively doped resin-based material of the present invention. By forming the outside cases for the transmitter 184 and the receiver 182 of the conductively doped resin-based material, an excellent electromagnetic absorbing structure is created. This electromagnetic absorber protects the transmitter 184 and the receiver 182 from outside electromagnetic interference. The conductively doped resin-based material also allows for intricate molding designs. Other features that are not typical to prior resin-based products include compatibility with electrostatic painting methods, excellent heat dissipation due to its thermal conductive properties, and excellent electrical conductivity.

In one embodiment the key pads 189 comprises the conductively doped resin-based material of the present invention. The conductively doped resin-based material provides an excellent alternative to metals, conductive inks, or carbon pills for forming the contact points. A less complex manufacturing process and/or lower cost process is thus derived. As one embodiment the key pad electrical contact points 189 keying mechanism is based on a first conductor, typically attached to the underside of the keypad, and a second conductor, located on a circuit board underlying a particular keypad in the array of keypads. When the keypad is pressed, the first conductor on the keypad is forced into direct contact with the second conductor on the circuit board matrix to complete a circuit. The key pad electrical contact points 189 formed of the conductively doped resin-based material of the present invention exhibit excellent conductivity as well as a longer life span due to the conductive matrix of fibers integrated within a pliable resin base.

In another preferred embodiment the connector jack 187 is formed of the conductively doped resin-based material of the present invention. While typically formed of metal, the connector jack 187 formed of the conductively doped resin-based material offers excellent electrical contact to the wireless system 180. In one embodiment the connector jack 187 is molded of the conductively doped resin-based material and metal plated and/or metal coated. In another embodiment the connector jack 187 is formed of the conductively doped resin-based material and is not metal plated.

Referring now to FIG. 15, an eleventh preferred embodiment of the present invention is illustrated. An instrument preamp 190 is shown. The instrument preamp 190 comprises the conductively doped resin-based material of the present invention. In the embodiment, any component or several components of the instrument preamp 190 comprise the conductively doped resin-based material. In various embodiments, the case 192, input and output jacks 194, potentiometers 196, and/or the keypad actuators 198, are formed of the conductively doped resin-based material of the present invention.

In one embodiment the outside case 192 for the instrument preamp 190 comprises the conductively doped resin-based material of the present invention. By forming the outside case 192 for the preamp 190 of the conductively doped resin-based material, an excellent electromagnetic absorbing structure is created. This electromagnetic absorber protects the preamp 190 from outside electromagnetic interference. The conductively doped resin-based material also allows for intricate molding designs. Other features that are not typical to prior resin-based products include compatibility with electrostatic painting methods, excellent heat dissipation due to its thermal conductive properties, and excellent electrical conductivity.

In one preferred embodiment the input and output jacks 194 are formed of the conductively doped resin-based material of the present invention. While typically formed of metal, the jacks 194 formed of the conductively doped resin-based material offers excellent electrical contact to the instrument preamp 190. In one embodiment the input and output jacks 194 are molded of the conductively doped resin-based material and metal plated and/or metal coated. In another embodiment, the input and output jacks 194 are formed of the conductively doped resin-based material and are not metal plated.

In another embodiment the key pads 198 comprise the conductively doped resin-based material of the present invention. The conductively doped resin-based material provides an excellent alternative to metals, conductive inks, or carbon pills for forming the contact points. A less complex manufacturing process and/or lower cost process is thus derived. As one embodiment, the key pad electrical contact points 198 keying mechanism is based on a first conductor, typically attached to the underside of the keypad, and a second conductor, located on a circuit board underlying a particular keypad in the array of keypads. When the keypad is pressed, the first conductor on the keypad is forced into direct contact with the second conductor on the circuit board matrix to complete a circuit. The key pad electrical contact points 190 formed of the conductively doped resin-based material of the present invention exhibit excellent conductivity as well as a longer life span due to the conductive matrix of fibers integrated within a pliable resin base.

Typical instrument preamps 190 utilize numerous potentiometers or pots 196 to allow the musician to “color” the sound that is that is subsequently sent to the amplifier. These pots 196 utilize contact points and connectors formed of metal. In one preferred embodiment, the volume and tone pots 196 have contact points and electrical connectors that are formed of the conductively doped resin-based material of the present invention. In this embodiment the pots 196 are formed of the conductively doped resin-based material and then metal plated and/or metal coated. In another embodiment, the pots 196 are formed of the conductively doped resin-based material of the present invention and are not metal plated and/or metal coated.

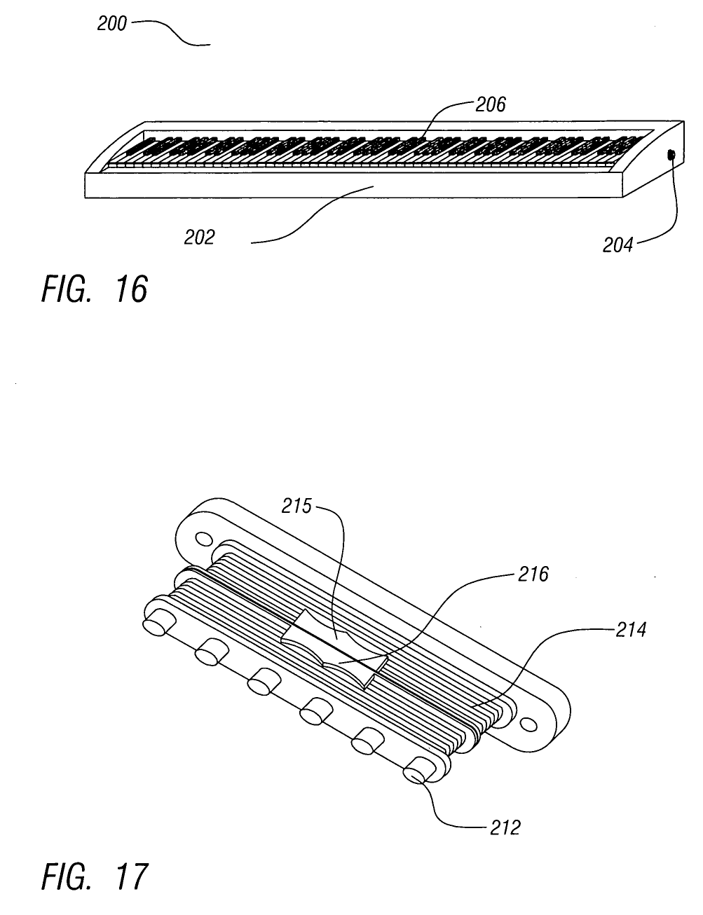

Referring now to FIG. 16, a twelfth preferred embodiment of the present invention is illustrated. An electronic keyboard 200 is shown. The electronic keyboard 200 comprises the conductively doped resin-based material of the present invention. In the embodiment, any component or several components of the electronic keyboard 200 comprise the conductively doped resin-based material. In various embodiments, the case 202, input and output jacks 204, and/or the keypad actuators 206, are formed of the conductively doped resin-based material of the present invention.

In one embodiment the outside case 202 for the electronic keyboard 200 comprises the conductively doped resin-based material of the present invention. By forming the outside case 202 for the keyboard 200 of the conductively doped resin-based material, an excellent electromagnetic absorbing structure is created. This electromagnetic absorber protects the keyboard 200 from outside electromagnetic interference. The conductively doped resin-based material also allows for intricate molding designs. Other features that are not typical to prior resin-based products include compatibility with electrostatic painting methods, excellent heat dissipation due to its thermal conductive properties, and excellent electrical conductivity.

In another preferred embodiment the input and output jacks 204 are formed of the conductively doped resin-based material of the present invention. While typically formed of metal, the jacks 204 formed of the conductively doped resin-based material offers excellent electrical contact to the keyboard 200. In the embodiment the input and output jacks 204 are molded of the conductively doped resin-based material and metal plated and/or metal coated. In another embodiment, the input and output jacks 204 are formed of the conductively doped resin-based material and are not metal plated.

In one embodiment the key pad actuators 206 comprise the conductively doped resin-based material of the present invention. The conductively doped resin-based material provides an excellent alternative to metals, conductive inks, or carbon pills for forming the contact points. A less complex manufacturing process and/or lower cost process is thus derived. As one embodiment the key pad electrical contact points 206 keying mechanism is based on a first conductor, typically attached to the underside of the keypad, and a second conductor, located on a circuit board underlying a particular keypad in the array of keypads. When the keypad is pressed, the first conductor on the keypad is forced into direct contact with the second conductor on the circuit board matrix to complete a circuit. The key pad electrical contact points 206 formed of the conductively doped resin-based material of the present invention exhibit excellent conductivity as well as a longer life span due to the conductive matrix of fibers integrated within a pliable resin base.

Referring now to FIG. 17, a thirteenth preferred embodiment of the present invention is illustrated. An electric guitar pickup 210 is shown. The electric guitar pickup 210 comprises the conductively doped resin-based material of the present invention. In various embodiments, the magnet 216, magnetic pole pieces 212, bobbin 213, and/or the coil conductor 214, are formed of the conductively doped resin-based material.

Typical electric guitar pickup construction utilizes a copper wire 214 wrapped around a bobbin 213 that is placed on a magnet. The pole pieces 212, which may or may not be magnetic, are placed inside the coil connecting to the magnet 216 and positioned under each individual string. When a string is vibrated, it warps the magnetic flux lines in the magnetic field and causes them to vibrate. The vibration causes motion of the flux lines relative to the coil of copper wire 214 and generates an electric signal. The signal is then sent through the conductor to eventually be processed and amplified by a guitar amplifier. The output or signal strength of the pickup can be made stronger by increasing the number of turns of the copper wire 214 on the bobbin 213 or by increasing the strength of the magnet.

In one embodiment of the present invention, the magnet 216 is placed between two separate coils of the electric guitar pickup 210. The magnet 216 is molded of a ferromagnetic conductively doped resin-based material of the present invention. After the magnet is molded it is subjected to a strong magnetic field in order to render it magnetic. In another embodiment the magnet is subjected to a strong magnetic field during the molding process in order to render it magnetic.

In another preferred embodiment the pole pieces 212 are formed of the ferromagnetic conductively doped resin-based material of the present invention. After the pole pieces 212 are molded they are subjected to a strong magnetic field in order to render them magnetic. In another embodiment the pole pieces 212 are subjected to a strong magnetic field during the molding process in order to render them magnetic. In yet another embodiment the pole pieces 212 are molded of the non-ferromagnetic conductively doped resin-based material and not magnetized. In yet another embodiment the pole pieces 212 are formed of metal.

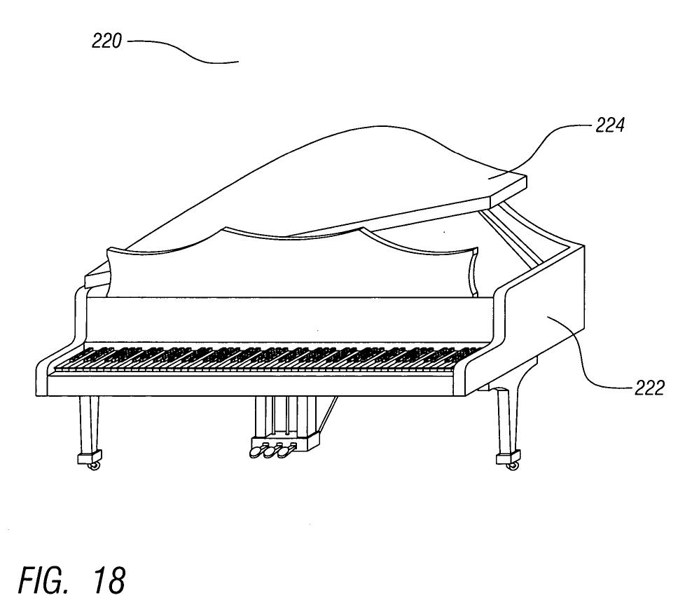

Referring now to FIG. 18, a fourteenth preferred embodiment of the present invention is illustrated. An acoustic piano 220 is shown. The acoustic piano 220 comprises the conductively doped resin-based material of the present invention. In various embodiments, the body 222, top 224, and/or soundboard are formed of the conductively doped resin-based material of the present invention.

Typical acoustic piano construction utilizes a sound board formed of spruce or a member of the spruce family. The reasons for using spruce in piano soundboard construction are similar to the reasoning for its use in acoustic guitar tops. Spruce has the characteristics of being low weight and extremely sturdy. It also is has a density that allows it to vibrate and be an excellent resonator of sound.

In this preferred embodiment, the soundboard (not shown) is formed of the conductively doped resin-based material of the present invention. The conductive loading percentage, by weight, and the base resin are chosen to allow greater absorption and less reflection of the sound waves. This selection allows the acoustic piano soundboard to mimic the acoustical properties and the tonal response of the natural spruce wood.

Typical piano construction utilizes a body and top made of a veneered wood of oak, mahogany, walnut and the like. Typically the core is formed of cheaper woods such as pine, pressed wood, and/or chipped wood. The core, while having some tonal qualities, typically is not considered to greatly influence the sound of the acoustic piano. In one embodiment of the present invention, the core for the body 222 and the top 224 are molded of the conductively doped resin-based material of the present invention. The core of the conductively doped resin-based material is then covered with a veneer of the desired wood for appearance. In another embodiment the core is formed of the conductively doped resin-based material and then painted to achieve the desired appearance. The acoustic piano 220 that utilizes a core for the body 222 and top 224 formed of the conductively doped resin-based material has increased tonal qualities due to the ability to adjust the resonating properties of the material.

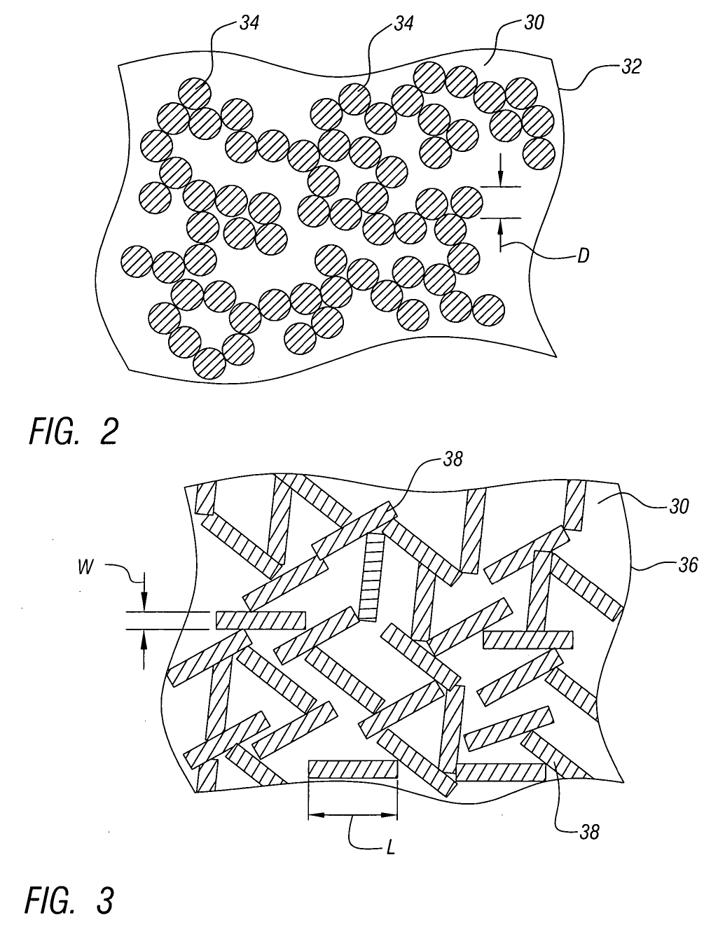

The conductively doped resin-based material typically comprises a micron powder(s) of conductor particles and/or in combination of micron fiber(s) substantially homogenized within a base resin host. FIG. 2 shows a cross section view of an example of conductively doped resin-based material 32 having powder of conductor particles 34 in a base resin host 30. In this example the diameter D of the conductor particles 34 in the powder is between about 3 and 12 microns.

FIG. 3 shows a cross section view of an example of conductively doped resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The micron conductive fibers 38 may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating materials include, but are not limited to, copper, nickel, cobalt, silver, gold, palladium, platinum, ruthenium, rhodium, and nichrome, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

These conductor particles and/or fibers are substantially homogenized within a base resin. As previously mentioned, the conductively doped resin-based materials have a sheet resistance of less than about 5 to more than about 25 ohms per square, though other values can be achieved by varying the doping parameters and/or resin selection. To realize this sheet resistance the weight of the conductor material comprises between about 20% and about 50% of the total weight of the conductively doped resin-based material. More preferably, the weight of the conductive material comprises between about 20% and about 40% of the total weight of the conductively doped resin-based material. More preferably yet, the weight of the conductive material comprises between about 25% and about 35% of the total weight of the conductively doped resin-based material. Still more preferably yet, the weight of the conductive material comprises about 30% of the total weight of the conductively doped resin-based material. Stainless Steel Fiber of 6-12 micron in diameter and lengths of 4-6 mm and comprising, by weight, about 30% of the total weight of the conductively doped resin-based material will produce a very highly conductive parameter, efficient within any EMF, thermal, acoustic, or electronic spectrum.

In yet another preferred embodiment of the present invention, the conductive doping is determined using a volume percentage. In a most preferred embodiment, the conductive doping comprises a volume of between about 4% and about 10% of the total volume of the conductively doped resin-based material. In a less preferred embodiment, the conductive doping comprises a volume of between about 1% and about 50% of the total volume of the conductively doped resin-based material though the properties of the base resin may be impacted by high percent volume doping.

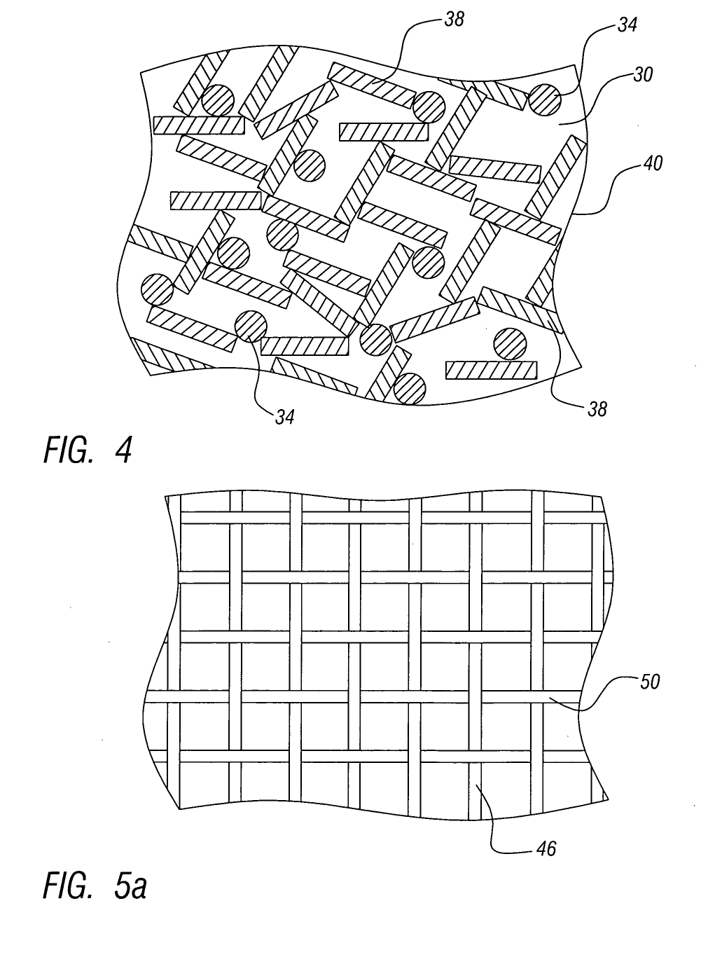

Referring now to FIG. 4, another preferred embodiment of the present invention is illustrated where the conductive materials comprise a combination of both conductive powders 34 and micron conductive fibers 38 substantially homogenized together within the resin base 30 during a molding process.

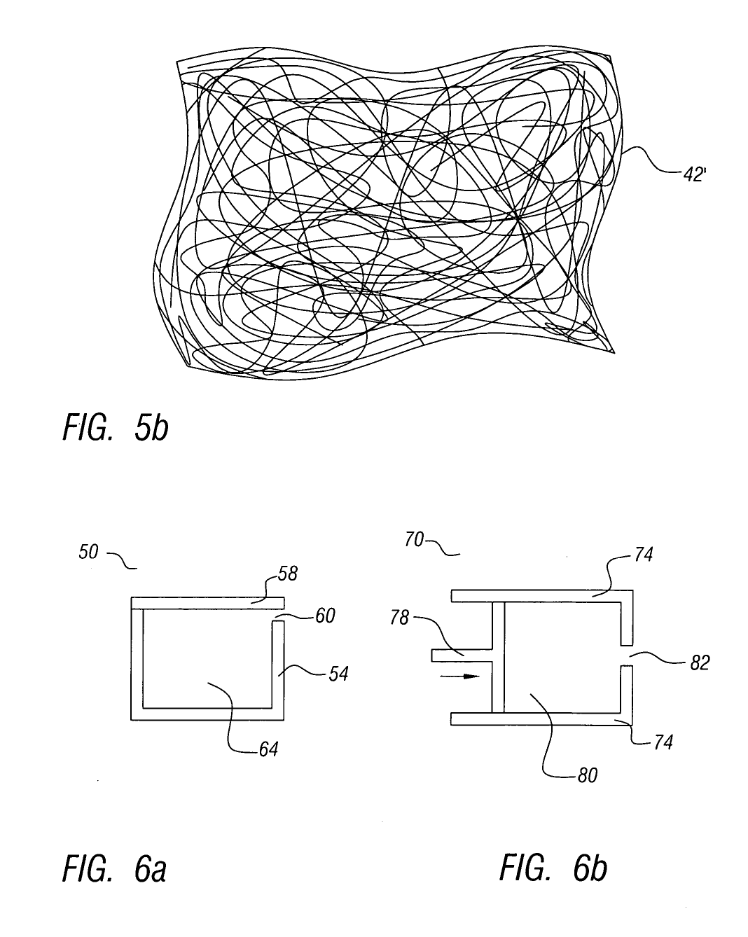

Referring now to FIGS. 5a and 5b, a preferred composition of the conductively doped, resin-based material is illustrated. The conductively doped resin-based material can be formed into fibers or textiles that are then woven or webbed into a conductive fabric. The conductively doped resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

Articles formed from conductively doped resin-based materials can be formed or molded in a number of different ways including injection molding, extrusion, calendaring, compression molding, thermoset molding, or chemically induced molding or forming. FIG. 6a shows a simplified schematic diagram of an injection mold showing a lower portion 54 and upper portion 58 of the mold 50. Conductively doped resin-based material is injected into the mold cavity 64 through an injection opening 60 and then the substantially homogenized conductive material cures by thermal reaction. The upper portion 58 and lower portion 54 of the mold are then separated or parted and the articles are removed.

FIG. 6b shows a simplified schematic diagram of an extruder 70 for forming articles using extrusion. Conductively doped resin-based material(s) is placed in the hopper 80 of the extrusion unit 74. A piston, screw, press or other means 78 is then used to force thermally molten, chemically-induced compression, or thermoset curing conductively doped resin-based material through an extrusion opening 82 which shapes the thermally molten curing or chemically induced cured conductively doped resin-based material to the desired shape. The conductively doped resin-based material is then fully cured by chemical reaction or thermal reaction to a hardened or pliable state and is ready for use. Thermoplastic or thermosetting resin-based materials and associated processes may be used in molding the conductively doped resin-based articles of the present invention.

The advantages of the present invention may now be summarized. An effective musical instrument or instrument component is achieved. A method to form a musical instrument or instrument component is achieved. The musical instrument or instrument component is molded of conductively doped resin-based materials. The acoustical, thermal, or electrical characteristics can be altered or the visual characteristics can be altered by forming a metal layer over the conductively doped resin-based material. The acoustical performance of a musical instrument is improved through use of a conductively doped resin-based material. The resonance qualities of a musical instrument are customized through the choice of and the doping percentage of the conductive materials.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the scope of the invention.

What is claimed is:

1. A musical instrument device comprising:
a user interface; and
a vibrating cavity wherein inputs from said user interface case air to vibrate in said vibrating cavity and wherein said vibrating cavity comprises conductively doped resin-based material comprising micron conductive materials in a resin-based material.

2. The device according to claim 1 wherein the percent by weight of said micron conductive materials is between about 20% and about 50% of the total weight of said conductively doped resin-based material.

3. The device according to claim 1 wherein said micron conductive materials comprise micron conductive fiber.

4. The device according to claim 2 wherein said micron conductive materials further comprise conductive powder.

5. The device according to claim 1 wherein said micron conductive materials are metal.

6. The device according to claim 1 wherein said micron conductive materials are non-conductive materials with metal plating.

7. The device according to claim 1 said user interface comprises strings comprising said conductively doped resin-based material.

8. The device according to claim 1 wherein said user interface comprises keys comprising said conductively doped resin-based material.

9. The device according to claim 1 further comprising an electrical pickup coupled to said vibrating cavity wherein said electrical pickup comprises said conductively doped resin-based material.

10. The device according to claim 9 further comprising electrical switches or connectors coupled to said electrical pickup wherein said electrical switches or connectors comprise said conductively doped resin-based material.

11. A musical instrument device comprising:
a user interface; and
a vibrating cavity wherein inputs from said user interface case air to vibrate in said vibrating cavity and wherein said vibrating cavity comprises conductively doped resin-based material comprising micron conductive fiber in a resin-based material and wherein the percent by weight of said micron conductive fiber is between about 20% and about 50% of the total weight of said conductively doped resin-based material.

12. The device according to claim 11 wherein said micron conductive fiber is nickel plated carbon micron fiber, stainless steel micron fiber, copper micron fiber, silver micron fiber or combinations thereof.

13. The device according to claim 11 further comprising micron conductive powder.

14. The device according to claim 13 wherein said micron conductive powder is nickel, copper, or silver.

15. The device according to claim 11 wherein said conductively doped resin-based material further comprises a ferromagnetic material.

16. The device according to claim 11 further comprising a metal layer overlying said conductively doped resin-based material.

17. The device according to claim 11 said user interface comprises strings comprising said conductively doped resin-based material.

18. The device according to claim 11 wherein said user interface comprises keys comprising said conductively doped resin-based material.

19. The device according to claim 1 further comprising an electrical pickup coupled to said vibrating cavity wherein said electrical pickup comprises said conductively doped resin-based material.

20. The device according to claim 19 further comprising electrical switches or connectors coupled to said electrical pickup wherein said electrical switches or connectors comprise said conductively doped resin-based material.

21. A method to form a musical instrument device, said method comprising:
providing a conductively doped, resin-based material comprising micron conductive materials in a resin-based host;
forming a using interface; and
molding said conductively doped, resin-based material into a vibrating cavity wherein inputs from said user interface case air to vibrate in said vibrating cavity.

22. The method according to claim 21 wherein the percent by weight of said micron conductive materials is between about 20% and about 50% of the total weight of said conductively doped resin-based material.

23. The method according to claim 21 wherein said micron conductive materials comprise micron conductive fiber.

24. The method according to claim 23 wherein said micron conductive materials further comprise conductive powder.

25. The method according to claim 21 wherein said micron conductive materials are metal.

26. The method according to claim 1 wherein said micron conductive materials are non-conductive materials with metal plating.

27. The method according to claim 21 wherein said step of molding comprises:
injecting said conductively doped, resin-based material into a mold;
curing said conductively doped, resin-based material; and
removing said vibrating cavity from said mold.

28. The method according to claim 21 wherein said step of molding comprises:
loading said conductively doped, resin-based material into a chamber;
extruding said conductively doped, resin-based material out of said chamber through a shaping outlet; and
curing said conductively doped, resin-based material to form said vibrating cavity.

29. The method according to claim 21 further comprising plating a metal layer overlying said conductively doped resin-based material.

30. The method according to claim 21 said user interface comprises said conductively doped resin-based material.
